(19) United States
(12) Patent Application Publication
(10) Pub. No.: US 2026/0219831 A1
(43) Pub. Date: Jul. 30, 2026

(54) SOUND TRACING DEVICE AND METHOD THAT CAN BE SYNCHRONIZED WITH GRAPHICS PERFORMANCE

(71) Applicant: INDUSTRY ACADEMY COOPERATION FOUNDATION OF SEJONG UNIVERSITY, Seoul (KR)

(72) Inventors: Woo Chan PARK, Seoul (KR); Eunjae KIM, Seoul (KR); Suk Won CHOI, Seoul (KR)

(73) Assignee: INDUSTRY ACADEMY COOPERATION FOUNDATION OF SEJONG UNIVERSITY, Seoul (KR)

(21) Appl. No.: 19/158,270

(22) PCT Filed: Jan. 26, 2024
(86) PCT No.: PCT/KR2024/001300

§ 371 Date: Aug. 20, 2025

(30) Foreign Application Priority Data
Feb. 21, 2023 (KR) 10-2023-0022945

(51) Int. Cl. G06F 3/16; G06T 1/20; H04S 7/00

(52) U.S. Cl. CPC G06F 3/165; G06T 1/20; H04S 7/303

(57) ABSTRACT

The present disclosure relates to a sound tracing device and method that can be synchronized with graphics performance, and the device includes: a graphic processing unit (GPU) which receives frame information (FI) and graphic data of a current frame and generates a final graphic for the current frame; a sound rendering unit (SRU) which receives the frame information and audio data and generates an audio processing result for the current frame; a sound generation unit (SGU) which receives the audio processing result and synchronizes performance between the graphic processing unit and the sound rendering unit to generate final audio for the current frame; and an extrapolation unit (ExU) which receives amplitude and an extrapolation level from the sound generation unit during the synchronization process and calculates an extrapolated amplitude.

### TECHNICAL FIELD

The present disclosure relates to sound processing technology, and more particularly, to a sound tracing device and method that can be synchronized with graphics performance capable of significantly improving audio performance while maintaining audio quality by calculating, for each frame, an extrapolated amplitude calculated through extrapolation based on current and previously generated amplitudes to generate final audio.

### BACKGROUND

In order to support a realistic virtual reality environment, it is essential to reproduce not only visual spatial sense but also auditory spatial sense in the virtual space. In order to reproduce high-quality auditory spatial sense, 3D sound technology using the Head Related Transfer Function (HRTF) is used. This reproduces auditory spatial sense using a pre-calculated filter or in a simple virtual space such as a rectangular shoe box. This method has limitations in reproducing realistic sound because physical effects are not reflected.

To solve these limitations, 3D sound technologies based on geometric methods or numeric methods are being announced. Among the geometric methods, the method of handling sound processing based on ray racing technology is called sound tracing (or audio ray tracing). The sound tracing is a sound rendering technique that implements realistic 3D sound by tracing sound propagation paths between a listener and a sound source. To this end, various sound propagation paths such as direct, reflection, and edge-diffraction are generated, and the final 3D sound is generated in an auralization process with this information.

In general, in a highly immersive virtual space such as virtual reality, graphics and audio should be synchronized and processed in response to situations that change every frame, such as a user's position and viewpoint. In other words, graphics and audio should be consistent in performance. Graphics are processed at high speed by a graphics processor such as a GPU (Graphic Processing Unit), and sound tracing is processed by a dedicated processor or SW. However, there may be a difference in performance between graphics and sound tracing, which may cause waiting time. Therefore, the lower the sound tracing performance, the longer the GPU pauses.

### Prior Art Document

### Patent Document

Korean Patent No. 10-1828908 (Feb. 7, 2018)

### DISCLOSURE

### Technical Problem

One embodiment of the present disclosure provides a sound tracing device and method that can be synchronized with graphics performance capable of significantly improving audio performance while maintaining audio quality by calculating, for each frame, an extrapolated amplitude calculated through extrapolation based on current and previously generated amplitudes to generate final audio.

### Technical Solution

In one embodiment, a sound tracing device can be synchronized with graphics performance, includes: a graphic processing unit (GPU) which receives frame information (FI) and graphic data of a current frame and generates a final graphic for the current frame; a sound rendering unit (SRU) which receives the frame information and audio data and generates an audio processing result for the current frame; a sound generation unit (SGU) which receives the audio processing result and synchronizes performance between the graphic processing unit and the sound rendering unit to generate final audio for the current frame; and an extrapolation unit (ExU) which receives amplitude and an extrapolation level from the sound generation unit during the synchronization process and calculates an extrapolated amplitude.

The sound rendering unit may generate sensitive data including a distance between a sound source and a listener in the current frame and a direction according to a viewpoint, and the amplitude as the audio processing result.

The sound generation unit may calculate the extrapolation level by comparing performance information received from each of the graphic processing unit and the sound rendering unit.

The sound generation unit may receive frames per second (FPS) as the performance information.

The sound generation unit may determine the extrapolation level according to a result of dividing the graphics performance by audio performance when the graphics performance is equal to or more than the audio performance.

The sound generation unit may calculate the final audio for the current frame using the audio processing result when the graphics performance is less than audio performance.

The sound generation unit may generate the final audio using the extrapolated amplitude for at least one subsequent frame consecutive to the current frame according to the extrapolation level.

The extrapolation unit may calculate the extrapolated amplitude through an extrapolation operation that calculates a third amplitude of a current level based on a first amplitude of a previous frame and a second amplitude of the current frame, and the extrapolation operation may be repeated until the current level, which increases with each repetition, becomes equal to the extrapolation level.

Among the embodiments, a sound tracing method which can be synchronized with graphics performance, includes: receiving, by a graphic processing unit (GPU), frame information (FI) and graphic data of a current frame and generating a final graphic for the current frame; receiving, by a sound rendering unit (SRU), the frame information and audio data and generating an audio processing result for the current frame; receiving, by a sound generation unit (SGU), comparing performance information received from each of the graphic processing unit and the sound rendering unit and calculating an extrapolation level for performance synchronization; receiving, by an extrapolation unit (ExU), amplitude and an extrapolation level from the sound generation unit and calculating an extrapolated amplitude; and generating, by the sound generation unit, final audio for the current frame using the audio processing result and the extrapolated amplitude.

The calculating of the extrapolation level may include determining the extrapolation level according to a result of dividing the graphics performance by audio performance when the graphics performance is equal to or more than the audio performance.

The generating of the final audio may include calculating the final audio for the current frame using the audio processing result when the graphics performance is less than the audio performance.

The generating of the final audio may include generating the final audio using the extrapolated amplitude for at least one subsequent frame consecutive to the current frame according to the extrapolation level.

### ADVANTAGEOUS EFFECTS

The disclosed technology may have the following effects. However, this does not mean that a specific embodiment should include all or only the following effects, and thus the scope of the disclosed technology should not be construed as being limited thereby.

According to the sound tracing device and method that can be synchronized with graphics performance of one embodiment of the present disclosure, it is possible to significantly improve audio performance while maintaining audio quality by calculating, for each frame, an extrapolated amplitude calculated through extrapolation based on current and previously generated amplitudes to generate final audio.

### BRIEF DESCRIPTION OF THE DRAWINGS

FIG. 1 is a diagram explaining a pipeline of sound tracing.

FIG. 2 is a diagram explaining the types of sound propagation paths.

FIG. 3 is a diagram explaining the configuration of a sound tracing device according to the present disclosure.

FIG. 4 is a diagram explaining an extrapolation operation according to the present disclosure.

FIG. 5 is a diagram explaining a sound tracing method according to the present disclosure.

### DETAILED DESCRIPTION

The description of the present disclosure is only an example for structural or functional explanation, and the scope of the present disclosure should not be construed as limited by the embodiments described herein. In other words, the embodiments can be modified in various ways and can have various forms, and the scope of the present disclosure should be understood to include equivalents that can realize the technical idea. In addition, the purpose or effect presented in the present disclosure does not mean that a specific embodiment should include all or only such effects, so the scope of the present disclosure should not be understood as limited thereby.

Meanwhile, the meaning of the terms described in the present specification should be understood as follows.

The terms such as “first”, “second”, etc. are intended to distinguish one component from another component, and the scope of the present disclosure should not be limited by these terms. For example, a first component may be named as a second component, and similarly, the second component may also be named as the first component.

When it is described that a component is “connected” to another component, it should be understood that one component may be directly connected to another component, but that other components may also exist between them. On the other hand, when it is described that a component is “directly connected” to another component, it should be understood that there is no other component between them. Meanwhile, other expressions that describe the relationship between components, such as “between” and “immediately between” or “neighboring” and “directly neighboring” should be interpreted similarly.

Singular expressions should be understood to include plural expressions unless the context clearly indicates otherwise, and terms such as “comprise or include” or “have” are intended to specify the existence of implemented features, numbers, steps, operations, components, parts, or combinations thereof, but should be understood as not precluding the possibility of the existence or addition of one or more other features, numbers, steps, operations, components, parts, or combinations thereof.

The identification symbols (e.g., a, b, c, etc.) used in each step are for convenience of explanation and do not indicate the sequence of the steps. Unless a specific order is explicitly stated in the context, the steps may occur in a different order than stated. That is, the steps may occur in the stated order, be performed substantially simultaneously, or be performed in the reverse order.

The present disclosure may be implemented as a computer-readable code on a computer-readable recording medium, which includes all types of storage devices that store data readable by a computer system. Examples of the computer-readable recording medium include ROM, RAM, CD-ROM, magnetic tape, floppy disks, optical data storage media, etc. Further, the computer-readable recording medium can be distributed across computer systems connected via a network, allowing the computer-readable code to be stored and executed in a distributed manner.

Unless otherwise defined, all terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

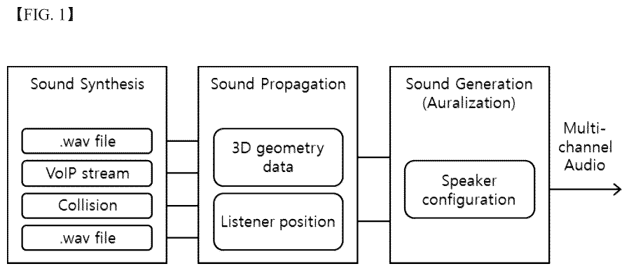

FIG. 1 is a diagram illustrating a pipeline of sound tracing.

Referring to FIG. 1, the sound tracing pipeline may include sound synthesis, sound propagation, and sound generation (auralization) steps. Among the sound tracing processing steps, the sound propagation step may be the most important step for providing immersion, and because the sound propagation step has very high computational complexity, it can be the most important step for overall performance.

The sound synthesis step may correspond to a step of generating sound effects based on user interaction. For example, the sound synthesis may perform processing on the sound generated when a user knocks on a door or drops an object, and may correspond to a technology commonly used in existing games, UIs, or the like.

The sound propagation step is the step that calculates the path along which the synthesized sound is transmitted to a listener through the virtual space. The sound propagation step may correspond to a step of processing acoustic characteristics (reflection coefficient, absorption coefficient, or the like) and sound characteristics (reflection, absorption, transmission, or the like) based on geometric characteristics (scene geometry) in the virtual space.

The sound generation step may be a step of generating the final 3D audio based on the configuration of a listener's speakers using the sound characteristic values (reflection/transmission/absorption coefficients, distance attenuation characteristics, or the like) calculated in the sound propagation step.

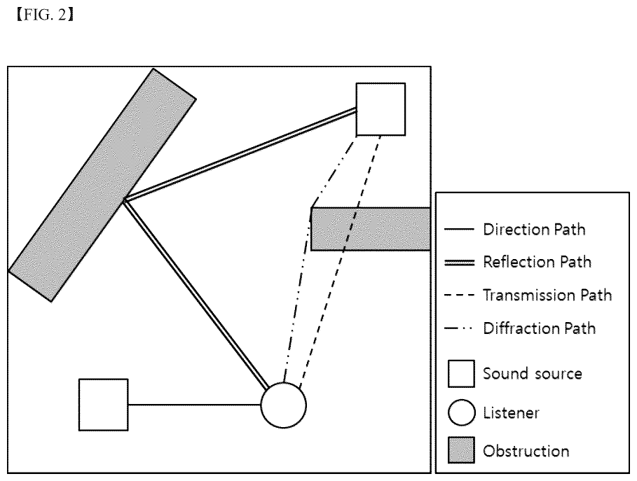

FIG. 2 is a diagram explaining types of sound propagation paths.

Referring to FIG. 2, a direct path may correspond to a path in which sound is directly transmitted between the listener and the sound source without any obstruction. A reflection path may correspond to a path in which sound is reflected after colliding with the obstruction and reaches the listener, and a transmission path may correspond to a path in which sound is transmitted to the listener by transmitting through the obstruction when there is the obstruction between the listener and the sound source. In addition, a diffraction path may correspond to a path in which sound is transmitted by being diffracted at an edge of an object.

Sound tracing may shoot rays from each location of multiple sound sources. Each shot ray may find a geometric object that collided with the ray, and generate a ray corresponding to reflection, transmission, and diffraction for the collided object. This process may be repeated recursively. In this way, rays shot from sound sources and rays shot from the listener may meet each other, and the path along which they meet may be called the sound propagation path. As a result, the sound propagation path may mean a valid path through which sound originating from the sound source location (or listener) goes through reflection, transmission, absorption, diffraction, or the like to arrive at the listener (or sound source). The final 3D audio may be calculated using these sound propagation paths.

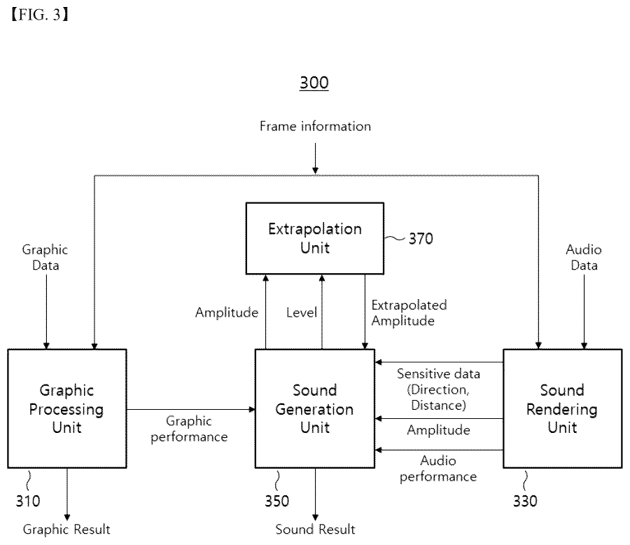

FIG. 3 is a diagram explaining the configuration of a sound tracing device according to the present disclosure.

Referring to FIG. 3, the sound tracing device 300 may include a graphic processing unit 310, a sound rendering unit 330, a sound generation unit 350, and an extrapolation unit 370.

In this case, the sound tracing device 300 according to the embodiment of the present disclosure does not have to include all of the above-mentioned components at the same time, and may be implemented by omitting some of the above-mentioned components or selectively including some or all of the above-mentioned components according to each embodiment. Hereinafter, the operation of each component will be described in detail.

The graphic processing unit 310 may receive frame information (FI) and graphic data of a current frame and generate a final graphic for the current frame. Here, the frame information (FI) is information about the current frame and may correspond to sensitive data that may change for each frame, such as the user's viewpoint, direction, and position. In addition, the graphic data is information used for graphic processing for the current frame and may include geometry data, texture data, light data, shading data, and the like. That is, the graphic processing unit 310 may generate the final graphic (graphic result) as a result of performing graphic processing for each frame.

The sound rendering unit 330 may receive the frame information and the audio data and generate an audio processing result for the current frame. Here, the audio data is information used for audio processing for the current frame and may include geometric data, material data, attenuation/reverberation, or the like. That is, the sound rendering device 330 may perform audio processing for each frame and generate the audio processing result.

In one embodiment, the sound rendering unit 330 may generate sensitive data including the distance between the sound source and the listener in the current frame and the direction according to a view point, and amplitude as an audio processing result. The sound rendering unit 330 may perform audio processing on the current frame, and may transmit sensitive data and amplitude information that change for each frame among the information generated during the audio processing to the sound generation unit 350.

The sound generation unit 350 may receive the audio processing result from the sound rendering unit 330 and synchronize the performance between the graphic processing unit 310 and the sound rendering unit 330 to generate the final audio for the current frame. The sound generation unit 350 may generate the final audio for each frame, and for this purpose, may receive the amplitude and frame-sensitive sensitive data from the sound rendering unit 330. In this case, the sensitive data may include the direction and distance of sound sources and the listener (or user), and since the corresponding information does not require a large amount of computation, the information can be calculated for each frame. The sound generation unit 350 may initiate an operation for performance synchronization when a performance difference occurs between the GPU and the SRU.

In one embodiment, the sound generation unit 350 may compare performance information received from each of the graphic processing unit 310 and the sound rendering unit 330 to calculate an extrapolation level. The sound generation unit 350 may calculate the extrapolation level used in a performance synchronization process when a performance difference is large. In this case, the extrapolation level may correspond to a numerical representation of the performance difference between the graphic processing unit 310 and the sound rendering unit 330, and may be used to determine the number of times an extrapolation operation for performance synchronization is performed.

In one embodiment, the sound generation unit 350 may receive frames per second (FPS) as the performance information. The sound generation unit 350 may define a performance index for comparing the performance of each of graphics and sound, and may selectively use a performance index representing frame processing performance for comparing the performance of graphics processing and sound processing performed for each frame. Although the frames per second is described as being used as performance information here, it is not necessarily limited thereto, and various performance indexes may of course be applied instead of the frames per second.

In one embodiment, the sound generation unit 350 may determine the extrapolation level based on the result of dividing the graphics performance by the audio performance when the graphics performance is equal to or more than the audio performance. For example, when the graphics performance is 30 and the audio performance is 10, the extrapolation level may be determined as 30/10=3. In addition, the sound generation unit 350 may define and use various formulas for calculating the extrapolation level using the graphics performance and the audio performance.

In one embodiment, the sound generation unit 350 may use the audio processing result to produce the final audio for the current frame when the graphics performance is less than the audio performance. That is, when the audio performance is sufficiently good as the graphics performance, the sound generation unit 350 may not perform an operation for performance synchronization, but may use the audio processing result received from the sound rendering unit 330 to calculate the final audio. Specifically, the sound generation unit 350 may use the amplitude and sensitive data for the current frame received from the sound rendering unit 330 to calculate the final audio.

In one embodiment, the sound generation unit 350 may generate the final audio using an extrapolated amplitude for at least one subsequent frame consecutive to the current frame according to the extrapolation level. In this case, the extrapolated amplitude may be calculated by the extrapolation unit 370, and the sound generation unit 350 may obtain the extrapolated amplitude in conjunction with the extrapolation unit 370. The sound generation unit 350 may initiate an operation for performance synchronization when a difference between the graphics performance and the sound performance exceeds a preset standard. To this end, the sound generation unit 350 may first calculate the extrapolation level using the graphics performance and the sound performance. Thereafter, the sound generation unit 350 may perform the final audio generation operation using the extrapolated amplitude calculated by the extrapolation unit 370 for frames consecutive to the next frame of the current frame according to the extrapolation level. For example, when the extrapolation level is 3, the sound generation unit 350 may generate the final audio based on the extrapolated amplitude for three consecutive frames including the next frame of the current frame.

The extrapolation unit 370 may receive the amplitude and extrapolation level from the sound generation unit 350 during the performance synchronization process between the graphic processing unit 310 and the sound rendering unit 330 and may calculate the extrapolated amplitude at each level. The extrapolated amplitude calculated by the extrapolation unit 370 may be transmitted to the sound generation unit 350 and used to generate the final audio.

In one embodiment, the extrapolation unit 370 may calculate the extrapolated amplitude through the extrapolation operation that calculates a third amplitude of the current level based on a first amplitude of the previous frame and a second amplitude of the current frame. In this case, the extrapolation operation may be repeated until the current level, which increases with each repetition, becomes equal to the extrapolation level. That is, when the extrapolation level is calculated by the sound generation unit 350, the extrapolation operation may be repeatedly performed equal to the extrapolation level from the next frame. To this end, the current level may increase by 1 each time the extrapolation operation is performed by the extrapolation unit 370, and the extrapolation operation may be terminated when the current level becomes equal to the extrapolation level. In addition, the extrapolation unit 370 may determine whether to start and end the operation by operating in conjunction with the sound generation unit 350.

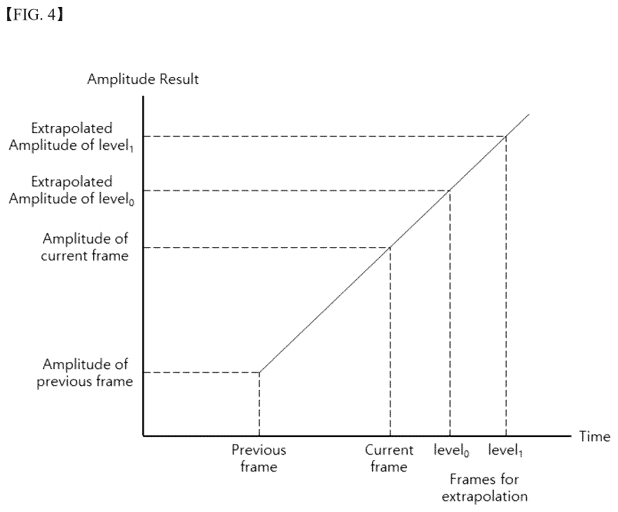

FIG. 4 is a diagram explaining the extrapolation operation according to the present disclosure.

Referring to FIG. 4, a process of calculating extrapolated amplitudes for two extrapolation levels (that is, level 0, level 1) may be illustrated. In this case, since the amplitude requires a large amount of computation, it can be assumed that the amplitude is generated once every few frames. That is, the extrapolation unit 270 may determine the extrapolated amplitude for each level through extrapolation based on the first amplitude of the previous frame time and the second amplitude of the current frame time.

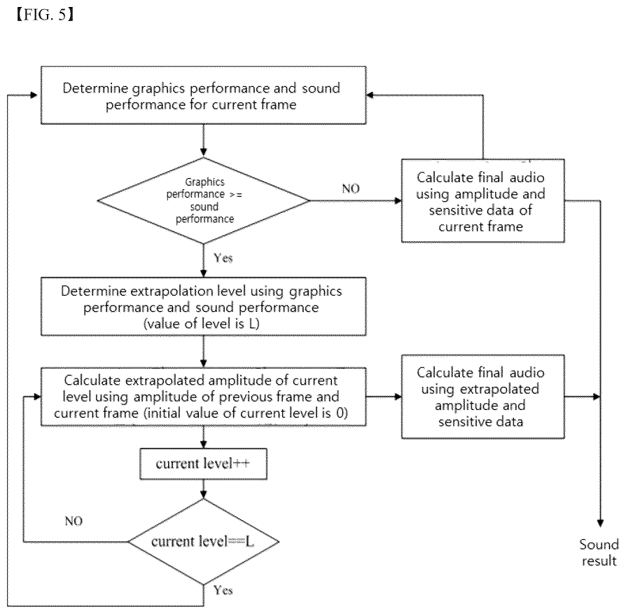

FIG. 5 is a diagram explaining a sound tracing method according to the present disclosure.

Referring to FIG. 5, the sound tracing device 130 can first determine the graphics performance and sound performance for the current frame. To this end, the sound generation unit 350 may receive the performance information from the graphic processing unit 310 and the sound rendering unit 330, respectively. In this case, each piece of performance information may correspond to the performance (graphic performance) of the GPU and the performance (audio performance) of the SRU in FIG. 3.

When the graphics performance is equal to or higher than the sound performance, the final audio may be calculated based on the amplitude and sensitive data of the current frame. Otherwise, the level (that is, the extrapolation level) of how many times to perform extrapolation may be determined based on the graphics performance and the sound performance. In this case, the level may be calculated by dividing the graphics performance by the sound performance.

Once the level is determined, the extrapolated amplitude may be calculated sequentially for each level, and the extrapolation process is illustrated in FIG. 4. The final audio may be calculated based on the extrapolated amplitude and the sensitive data. The process may be performed sequentially for each level, and may be repeated until the current level becomes equal to the extrapolated level. That is, when the current level becomes equal to the extrapolated level, the extrapolation operation may be terminated, and the operation for performance collection and comparison may be performed again from the next frame.

In order to realize an immersive virtual space, graphics and audio need to be synchronized for each frame, and the sound tracing for realistic 3D audio needs to be performed in synchronization with the graphics. The sound tracing method according to the present disclosure can effectively increase performance while maintaining audio quality even when the audio performance due to sound tracing is low.

That is, in the case of amplitude, which is a part with a large amount of computation, an extrapolated amplitude, which is an amplitude calculated through extrapolation using the current and previously generated amplitudes, can be calculated for each frame. The final audio can be calculated for each frame using the extrapolated amplitude and the sensitive data. Through this, the sound tracing method according to the present disclosure can significantly improve audio performance while maintaining audio quality. As a result, since the graphics performance and the audio performance are equivalent, the graphics and sound can be effectively synchronized.

Although the present disclosure has been described above with reference to preferred embodiments thereof, it will be understood by those skilled in the art that various modifications and changes may be made to the present disclosure without departing from the spirit and scope of the present disclosure as set forth in the claims below.

### DETAILED DESCRIPTION OF MAIN ELEMENTS

300: sound tracing device
310: graphic processing unit 330: sound rendering unit
350: sound generation unit 370: extrapolation unit

1. A sound tracing device can be synchronized with graphics performance, the sound tracing device comprising:
a graphic processing unit (GPU) which receives frame information (FI) and graphic data of a current frame and generates a final graphic for the current frame;
a sound rendering unit (SRU) which receives the frame information and audio data and generates an audio processing result for the current frame;
a sound generation unit (SGU) which receives the audio processing result and synchronizes performance between the graphic processing unit and the sound rendering unit to generate final audio for the current frame; and
an extrapolation unit (ExU) which receives amplitude and an extrapolation level from the sound generation unit during the synchronization process and calculates an extrapolated amplitude.

2. The sound tracing device of claim 1, wherein the sound rendering unit generates sensitive data including a distance between a sound source and a listener in the current frame and a direction according to a viewpoint, and the amplitude as the audio processing result.

3. The sound tracing device of claim 1, wherein the sound generation unit calculates the extrapolation level by comparing performance information received from each of the graphic processing unit and the sound rendering unit.

4. The sound tracing device of claim 3, wherein the sound generation unit receives frames per second (FPS) as the performance information.

5. The sound tracing device of claim 3, wherein the sound generation unit determines the extrapolation level according to a result of dividing the graphics performance by audio performance when the graphics performance is equal to or more than the audio performance.

6. The sound tracing device of claim 3, wherein the sound generation unit calculates the final audio for the current frame using the audio processing result when the graphics performance is less than audio performance.

7. The sound tracing device of claim 5, wherein the sound generation unit generates the final audio using the extrapolated amplitude for at least one subsequent frame consecutive to the current frame according to the extrapolation level.

8. The sound tracing device of claim 7, wherein the extrapolation unit calculates the extrapolated amplitude through an extrapolation operation that calculates a third amplitude of a current level based on a first amplitude of a previous frame and a second amplitude of the current frame, and
the extrapolation operation is repeated until the current level, which increases with each repetition, becomes equal to the extrapolation level.

9. A sound tracing method which can be synchronized with graphics performance and performed by a sound tracing device, the sound tracing method comprising:
receiving, by a graphic processing unit (GPU), frame information (FI) and graphic data of a current frame and generating a final graphic for the current frame;
receiving, by a sound rendering unit (SRU), the frame information and audio data and generating an audio processing result for the current frame;
receiving, by a sound generation unit (SGU), comparing performance information received from each of the graphic processing unit and the sound rendering unit and calculating an extrapolation level for performance synchronization;
receiving, by an extrapolation unit (ExU), amplitude and an extrapolation level from the sound generation unit and calculating an extrapolated amplitude; and
generating, by the sound generation unit, final audio for the current frame using the audio processing result and the extrapolated amplitude.

10. The sound tracing method of claim 9, wherein the calculating of the extrapolation level includes determining the extrapolation level according to a result of dividing the graphics performance by audio performance when the graphics performance is equal to or more than the audio performance.

11. The sound tracing method of claim 9, wherein the generating of the final audio includes calculating the final audio for the current frame using the audio processing result when the graphics performance is less than the audio performance.

12. The sound tracing method of claim 10, wherein the generating of the final audio includes generating the final audio using the extrapolated amplitude for at least one subsequent frame consecutive to the current frame according to the extrapolation level.
